(19) United States
(12) Patent Application Publication
(10) Pub. No.: US 2023/0243433 A1
(43) Pub. Date: Aug. 3, 2023

(54) DIRECTIONAL VALVE AND VALVE CAGE FOR A DIRECTIONAL VALVE

(71) Applicant: WOCO Industrietechnik GmbH, Bad Soden-Salmuenster (DE)

(72) Inventors: Eberhard Geissel, Kuenzell (DE); Torsten Hofmann, Bad Soden-Salmuenster (DE); Martin Hofmann, Bad Soden-Salmuenster (DE); Michael Kolb, Bad Soden-Salmuenster (DE); Rita Spomer, Waechtersbach (DE)

(73) Assignee: WOCO Industrietechnik GmbH, Bad Soden-Salmuenster (DE)

(21) Appl. No.: 18/001,394

(22) PCT Filed: Jun. 10, 2021
(86) PCT No.: PCT/EP2021/065645

§ 371 Date: Dec. 9, 2022

(30) Foreign Application Priority Data
Jun. 10, 2020 (DE) 102020115516.6

(51) Int. Cl. F16K 11/085; F16L 37/252; F16K 27/06

(52) U.S. Cl. CPC F16K 11/0853; F16K 27/065; F16L 37/252; F01P 2007/146

(57) ABSTRACT

A directional control valve for handling fluids, such as cooling and/or heating fluids, may be used in a motor vehicle, such as an electrically operated motor vehicle. The directional control value may include: a valve housing defining at least one fluid channel including at least one fluid inlet and at least one fluid outlet, and at least one fluid connecting piece adapted to the at least one fluid inlet or fluid outlet. The fluid connecting piece may be positively connected to the valve housing using a bayonet mechanism. The directional control may include a multi-way valve.

### CROSS REFERENCE TO RELATED APPLICATIONS

This patent application is a U.S. National Stage Application of International Application No. PCT/EP2021/065645, filed Jun. 10, 2021, which claims priority to German Patent Application No. 10 2020 115 516.6, filed Jun. 10, 2020, each of which is incorporated herein by reference in its entirety.

### BACKGROUND

### Field

The present disclosure relates to a directional control valve for handling fluids, in particular cooling and/or heating fluids, in a motor vehicle, in particular in an electrically operated motor vehicle. The present disclosure furthermore provides a valve cage for a directional control valve of this type.

### Related Art

Generic directional control valves, in particular multi-way valves, are used for the thermal management in particular in a motor vehicle, i.e. in particular for distributing, shutting off, and mixing cooling and heating fluids.

The multi-way valves generally comprise a valve housing, a valve member, which is movable in relation thereto, for setting a fluid flow through the multi-way valve, a valve cover for closing the valve housing, and fluid connecting pieces, which are fastened thereto and to which fluid lines can be connected.

Fluid connecting pieces are currently welded to the valve housing or are screw-connected thereto. Both connecting technologies have turned out to be disadvantageous insofar as the welded connection cannot be disassembled in a destruction-free manner, and the screw-connection leads to high costs of the multi-way valve. The same applies to the fastening of the valve cover to the valve housing.

A multi-way valve for controlling liquid circuits in cooling systems of internal combustion engines is known from DE 20 2017 000 564 U1. A sealing package, which, on a side facing away from the multi-way valve, has devices for fastening connections and lines for the fluid medium, can be connected to the multi-way valve via a locking connection. For this purpose, the sealing package has guides in the form of grooves on its outer surfaces, and the valve housing has counter guide elements in the form of ribs on the housing connecting pieces, in order to ensure a guidance and correct positioning of the sealing package within the valve housing connecting piece. The sealing package can then be fastened to the valve housing connecting piece by means of a locking connection.

However, the realization of the guide elements is structurally complex and requires a high manufacturing accuracy. The assembly furthermore turns out to be difficult because the installer has to always set the correct orientation of sealing package and valve housing connecting piece in order to be able to connect them to one another. According to DE 20 2017 000 564 U1, it is further not possible to fasten a valve housing cage so as to be capable of being disassembled.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 shows a perspective view of a section of a directional control valve according to an exemplary embodiment of the disclosure.

FIG. 2 shows a perspective exploded view of a directional control valve according to an exemplary embodiment of the disclosure.

FIG. 3 shows a perspective view of the directional control valve from FIG. 2, in a pre-assembly state, according to an exemplary embodiment of the disclosure.

FIG. 4 shows a perspective view of the directional control valve according to FIGS. 2 and 3, in an intermediate assembly state, according to exemplary embodiments of the disclosure.

FIG. 5 shows a perspective illustration of the directional control valve according to FIGS. 2 to 4, in a final assembly state, according to exemplary embodiments of the disclosure.

FIG. 6 shows a sectional view of the directional control valve from FIG. 5, according to an exemplary embodiment of the disclosure.

FIG. 7 shows a further sectional view of the directional control valve according to FIG. 5, according to an exemplary embodiment of the disclosure.

FIG. 8 shows a further sectional view of the directional control valve according to FIG. 5, according to an exemplary embodiment of the disclosure.

FIG. 9 shows a schematic illustration of an exemplary directional control valve, according to an exemplary embodiment, which is integrated in a coolant circuit of a motor vehicle according to a first operating state.

FIG. 10 shows the coolant circuit according to FIG. 9, in a second operating state, according to an exemplary embodiment of the disclosure.

FIG. 11 shows a perspective illustration of a valve cage according to an exemplary embodiment of the disclosure.

The exemplary embodiments of the present disclosure will be described with reference to the accompanying drawings. Elements, features and components that are identical, functionally identical and have the same effect are — insofar as is not stated otherwise — respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, and components, have not been described in detail to avoid unnecessarily obscuring embodiments of the disclosure.

It is an object of the present disclosure to improve the disadvantages of conventional systems, in particular to create a directional control valve, which can be disassembled, and a valve cage for a directional control valve of this type, which can be produced cost-efficiently and which can be disassembled or assembled easily, respectively, and which optionally provides for a fastening of a valve cover, which can be disassembled.

According to a first aspect of the present disclosure, a directional control valve, in particular multi-way valve, for handling fluids, in particular cooling and/or heating fluids, in a motor vehicle, in particular in an electrically operated motor vehicle, is provided. Generic directional control valves are also referred to as X/Y-way valves, whereby X refers to the number of the inlets and/or outlets, and Y to the number of the fluid connections between inlets and outlets, which can be provided simultaneously. A 3/2-way valve can thus have two inlets and one outlet, or one inlet and two outlets. In the latter case, a fluid flow, for example, can be fed to the valve housing via the inlet, and can be discharged from the valve housing in the form of two partial flows, in each case via an outlet. In the case of this example, two fluid connections are provided, namely in each case one between the respective outlet and the common inlet. Multi-way valves of this type can be used, for example, for the cooling water distribution in motor vehicles. A multi-way valve thereby serves the purpose of setting the fluid flow, such as the cooling water flow. By means of multi-way valves, a fluid flow, for example, can be divided into two partial flows, two partial flows can be brought together to form one fluid flow, one fluid flow can optionally be discharged via different fluid outlets, or different fluid circuits can be realized. By means of the optional discharge of the fluid flow via different fluid outlets, the fluid flow can be fed to different heat sources, such as engines and batteries, and heat sinks, such as cooling aggregates, in particular via a single valve. By bringing together two partial inlet flows (partial fluid flows) to form one outlet fluid flow, in particular the cooling capacity can be increased compared to one heat source, while two heat sources can be cooled via one inlet flow by distributing one inlet fluid flow to two outlet fluid flows (partial fluid flows).

The directional control valve according to the disclosure can be integrated, for example, in a coolant circuit of a motor vehicle, in particular in an electrically operated motor vehicle, which serves in particular for the motor vehicle engine cooling and which comprises a cooling as well as a heating device. The directional control valve according to the disclosure can be configured to bypass the heating device in an operating state, so that engine fluid coming from the motor vehicle and cooled by the cooling device is fed to the motor vehicle engine again. The directional control valve can further assume another operating position, in which the engine fluid coming from the motor vehicle engine and cooled by the cooling device is initially fed to the heating device for heating and optionally predetermined temperature control before it ends up back in the motor vehicle engine.

The directional control valve according to the disclosure comprises a valve housing defining at least one fluid channel comprising at least one fluid inlet and at least one fluid outlet. The fluid inlet and the fluid outlet can be realized as openings in the valve housing. The valve housing can have, for example, a hollow-cylindrical structure and/or can be open to the bottom and top. A valve housing wall limits a valve chamber. A fluid connection between the fluid inlet and the fluid outlet defines the fluid channel. In other words, a fluid introduced into the valve housing via the fluid inlet can be discharged from the valve housing again via the valve outlet.

The directional control valve according to the disclosure furthermore comprises at least one fluid connecting piece, which is adapted to the at least one fluid inlet or fluid outlet and to which a fluid line, for example to the motor vehicle engine, the cooling or heating device, can be connected. The fluid connecting piece can thus be understood as interface between fluid line and directional control valve or valve housing, respectively.

According to the first aspect of the present disclosure, the fluid connecting piece is positively connected to the valve housing by means of a bayonet mechanism. A connection, which can be realized in a structurally simple manner and which can be operated quickly and easily by an installer, is thus possible between fluid connecting piece and valve housing. The bayonet mechanism can further be designed so as to be releasable, in particular so that it can be disassembled. The bayonet mechanism can be configured so that, by interconnecting fluid connecting piece and valve housing, in particular fluid inlet or fluid outlet, and subsequent rotation of at least one of the two components relative to the other component, an in particular releasable fastening is realized between fluid connecting piece and valve housing, which can be reversed again or disassembled, respectively, in particular in reverse assembly sequence.

In an exemplary embodiment of the directional control valve according to the disclosure, the at least one fluid connecting piece, which is formed in particular cylindrically, in particular hollow-cylindrically, has an at least partially circumferential stop projection on its outer circumference. The stop projection is arranged, for example, in the region of an axial end of the fluid connecting piece. The stop projection can further be configured to come into an axial stop contact, in particular for limiting the axial insertion width of the fluid connecting piece into the valve housing. The stop projection can be configured to come into stop contact with a valve housing wall, which limits at least one fluid inlet or fluid outlet, in order to establish an axial insertion position of the fluid connecting piece.

In a further exemplary embodiment of the directional control valve according to the disclosure, the bayonet mechanism comprises at least one engagement element, such as a retaining lug or a retaining groove, which is formed on the outer circumference of the fluid connecting piece, and at least one further engagement element, such as a retaining lug or a retaining groove, which is formed on the valve housing and which projects into a fluid passage cross section, which is limited by the at least one fluid inlet or valve outlet. The engagement elements of the fluid connecting piece and of the valve housing can be configured to come into engagement with one another and/or to cooperate with one another in order to realize the bayonet mechanism and/or to fasten the fluid connecting piece to the valve housing, in particular in a releasable manner. In an exemplary further development, the valve housing-side engagement element is arranged on an opening wall of the fluid inlet or of the fluid outlet limiting the fluid passage cross section, and projects into the fluid passage cross section. In an alternative design, the valve housing-side engagement element is arranged behind the opening wall of the valve housing limiting the fluid passage cross section, viewed in the axial or insertion direction, respectively, of the fluid connecting piece, the engagement element is in particular provided in the region of the valve chamber.

According to an exemplary further development of the present disclosure, the fluid connecting piece-side engagement element is configured to reach past the at least one further valve housing-side engagement element when the fluid connecting piece is inserted into the at least one fluid inlet or fluid outlet in the insertion direction. The fluid connecting piece and the valve housing can be shape-adapted to one another and/or an insertion width of the fluid connecting piece into the valve housing can be selected so that the fluid connecting piece-side engagement element reaches axially past the valve housing-side engagement element in the insertion direction. In other words, in an assembly state, the fluid connecting piece-side engagement element is arranged farther inwards in the valve chamber than the valve housing-side engagement element.

According to an exemplary embodiment of the present disclosure, the bayonet mechanism is configured in such a way that, when the fluid connecting piece is inserted into the at least one fluid inlet or fluid outlet by means of a rotation of the fluid connecting piece, in particular relative to the valve housing, the fluid connecting piece-side engagement element comes into engagement with the further valve housing-side engagement element. The fluid connecting piece-side engagement element can thereby overlap the valve housing-side engagement element in the insertion direction. Due to the overlap of the engagement elements, the fluid connecting piece is secured in the axial or insertion, respectively, and disassembly direction. The fluid connecting piece is thus in particular releasably fastened to the valve housing in a structurally simple way. According to an exemplary further development of the directional control valve according to the disclosure, the directional control valve has a final assembly position, which is assumed in the case of an aligned orientation of the at least one fluid connection-side engagement element and of the at least one valve housing-side engagement element. It is clear thereby that the cross sections of the fluid connecting piece-side and valve housing-side engagement elements do not necessarily have to be dimensioned identically. It is sufficient when the two engagement elements are oriented so as to be aligned with one another in such a way that, viewed in the insertion direction, one of the engagement elements is completely covered by the other engagement element.

According to a further exemplary embodiment of the directional control valve according to the disclosure, an axis of rotation of the fluid connecting piece, in particular that axis of rotation, about which the fluid connecting piece is rotated in order to activate the bayonet mechanism, and the insertion direction of the fluid connecting piece in the at least one fluid inlet or fluid outlet are oriented parallel to one another.

The axis of rotation and the axis of the insertion direction are in particular oriented coaxially to one another. A particularly simple assembly and disassembly is possible by means of this orientation of the axes to one another. The insertion position and direction is further predefined, so that an incorrect assembly can be avoided.

In a further exemplary embodiment of the directional control valve according to the disclosure, the engagement elements are arranged on the fluid connecting piece and/or on the valve housing in such a way that the engagement elements are free from a flow-around of the fluid flow, which is to be handled. In other words, the engagement elements do not project into the fluid channel and/or into a region of the valve chamber, around which the fluid flow flows. Turbulences, flow resistances, and pressure losses are avoided thereby.

In a further exemplary embodiment of the directional control valve according to the disclosure, a valve cage, which is formed in particular according to the second aspect according to the disclosure of the present disclosure, which will be described further below, is installed in the valve housing. In the context of the present disclosure, a valve cage is to be understood to be a device, which is configured to guide a valve member for setting the fluid flow within the valve housing and/or to store it between the various operating states of the valve when handling the fluid flow. The valve member can thereby cooperate in the various operating states of the directional control valve and/or can be guided by the latter when axially inserting the valve member into the valve housing or the valve cage, respectively, and/or can store the valve member during a rotative actuating movement of the latter.

According to a further exemplary embodiment of the present disclosure, the bayonet mechanism is configured to establish a positive fastening between valve cage, valve housing, and the at least one fluid connecting piece. It is provided, for example, that an assembly and disassembly direction of the valve cage is oriented into the valve housing transversely, in particular vertically, to an assembly/disassembly and insertion direction of the fluid connecting piece. The bayonet mechanism can thereby prevent a disassembly of the valve cage in the installation direction thereof as well as a disassembly of the fluid connecting piece in the insertion direction thereof. The bayonet mechanism according to the disclosure thus makes it possible in a structurally simple way to simultaneously fasten the fluid connecting piece and the valve cage to the valve housing, in particular so as to be capable of being disassembled or released, respectively. The bayonet mechanism can furthermore assume operating states, in which it is possible to fasten either only the fluid connecting piece or only the valve cage to the valve housing.

According to an exemplary further development of the multi-way valve according to the disclosure, the bayonet mechanism has at least one fluid connecting piece-side engagement element, such as a retaining lug or retaining groove, which is configured to come into a positive engagement with the valve cage. For example, this is the same engagement element, which can cooperate with the valve housing-side engagement element for fastening the fluid connecting piece to the valve housing. For example, the fluid connection-side engagement element is a projection, which revolves at least partially on the outer circumference of the fluid connecting piece, in particular in an axial end region of the fluid connecting piece, or an at least partially circumferential groove or depression, respectively.

According to an exemplary further development of the directional control valve according to the disclosure, the bayonet mechanism is configured in such a way that a positive engagement between the fluid connecting piece, in particular the fluid connection-side engagement element and the valve cage is involved when the fluid connecting piece is inserted into the at least one fluid inlet or fluid outlet as a result of a rotation of the valve cage. The directional control valve can therefore have an intermediate assembly state, in which the fluid connecting piece is inserted into the fluid housing, and the valve cage is installed in the valve housing, whereby it can be provided that the valve cage is installed before the at least one fluid connecting piece. The intermediate assembly state is characterized in that the valve cage is installed in the valve housing so as to still be capable of being released or disassembled, respectively, and/or in that the fluid connecting piece is inserted into the valve housing, so as to still be capable of being released or assembled, respectively. After rotation of the valve cage has taken place, in particular relative to the valve housing and/or the fluid connecting piece, the bayonet mechanism is activated and fluid connecting piece as well as valve cage are positively fastened to the valve housing. The valve cage and the fluid connecting piece can thus be simultaneously fastened to the valve housing in just a few steps.

It applies to all exemplary embodiments of the present disclosure that the bayonet mechanism can be configured in such a way that a slight rotational movement of a few degrees, in particular of less than 90 degrees, less than 60 degrees, less than 45 fewer degrees, less than 30 degrees, or less than 15 degrees, is already sufficient to realize the fastening.

In an exemplary embodiment of the present disclosure, the valve cage comprises at least two recesses assigned to the at least one fluid inlet and to the at least one fluid outlet. It is clear that one of each recesses is to be assigned to a fluid inlet or fluid outlet, respectively, in the assembly state. The recesses can be designed so that they are part of the bayonet mechanism. The recesses can have a first circumferential region or passage, respectively, which defines a first opening cross section, and a second circumferential region or passage, respectively, which differs from the first opening cross section and which defines a second opening cross section. The first opening cross section can be formed in a partially circular manner and/or the second opening cross section can be formed essentially rectangularly. For example, the second opening cross section is larger than the first opening cross section.

According to an exemplary further development of the directional control valve according to the disclosure, the first circumferential region overlaps with the at least one fluid connection-side engagement element in the insertion direction for assuming the positive engagement between fluid connecting piece, in particular fluid connection-side engagement element, and valve cage. To assume the positive engagement between fluid connecting piece and valve cage, the fluid connection-side engagement element can furthermore reach past the first circumferential region in the insertion direction. The fluid connecting piece can therefore act as a type of securing pin against a disassembly of the valve cage. The overlapping of the fluid connection-side engagement element with the first circumferential region, in particular a valve cage wall surrounding the first circumferential region or the recess, respectively, can simultaneously secure the valve cage and the fluid connecting piece against a disassembly.

According to an exemplary further development of the directional control valve according to the disclosure, the first opening cross section is essentially shape-adapted to an outer circumference of the at least one fluid connecting piece. The first opening cross section can have a diameter, which essentially corresponds to an outer diameter of the outer circumference of the fluid connecting piece.

In a further exemplary embodiment of the directional control valve according to the disclosure, the directional control valve has a pre-assembly state. In the pre-assembly state, the valve cage can be installed in the valve housing in such a way that the at least one fluid inlet or the at least one valve outlet is oriented, in particular in alignment, with the second opening cross section of the recess. The directional control valve can furthermore have an intermediate assembly state, in which the fluid connecting piece is inserted through the fluid inlet or fluid outlet and the valve cage-side recess, in particular the second opening cross section. In the event that the second opening cross section is larger than the first opening cross section, a particularly simple assembly is possible because it is ensured that the fluid connecting piece can readily be installed in the valve housing and the valve cage. The directional control valve can furthermore have a final assembly state, in which the first opening cross section is oriented with the fluid inlet or fluid outlet, and the fluid connecting piece is arranged in the first opening cross section. To assume the pre-assembly state, the valve cage can be installed in the interior of the valve housing in a translatory manner. To assume the intermediate assembly state, the at least one fluid connecting piece is inserted in the axial direction thereof, which defines an insertion direction, into the valve housing and the valve cage in a translatory manner. To assume the final assembly state as well as to activate the bayonet mechanism and thus to fasten fluid connecting piece, valve cage, and valve housing to one another, at least one of the three components is rotated relative to the other two components.

The valve cage is rotated in particular about the axial installation direction thereof, in particular by a few degrees, in particular by less than 90 degrees, less than 60 degrees, less than 45 degrees, less than 30 degrees, or less than 15 degrees.

According to a further aspect of the present disclosure, which can be combined with the preceding aspects and exemplary embodiments, a valve cage for a directional control valve, in particular multi-way valve, which is formed in particular according to the disclosure and according to one of the preceding aspects or exemplary embodiments, for handling fluids, in particular cooling and/or heating fluids, in a motor vehicle, in particular in an electrically operated motor vehicle, is provided. The valve cage according to the disclosure generally serves the purpose of guiding a valve member for setting the fluid flow within the valve housing and/or to store it between the various operating states of the valve when handling the fluid flow. The valve member can thereby cooperate in the various operating states of the directional control valve and/or can be guided by the latter during the axial installation of the valve member in the valve housing or the valve cage, respectively, and/or can store the valve member during a rotative actuating movement of the latter.

The directional control valve has a valve housing defining at least one fluid channel comprising at least one fluid inlet and at least one fluid outlet and at least one fluid connecting piece adapted to the at least one fluid inlet or fluid outlet.

The valve cage according to the disclosure comprises a cage structure, which is at least partially adapted to an inner contour of the valve housing. For example, the valve housing is formed essentially as hollow cylinder. The same can apply to the cage structure.

The cage structure has at least two recesses, which can be assigned to the at least one fluid inlet and the at least one fluid outlet. The two recesses in each case have a first circumferential region defining a first opening cross section, and a second circumferential region, which differs from the first opening section and which defines a second opening cross section. Due to the particular design of the valve cage, in particular the recesses thereof, which, on the one hand, serve for guiding fluid as usual, in addition for fastening valve housing, fluid connecting piece, and valve cage. They can therefore be part of a bayonet mechanism for positively connecting fluid connecting piece, valve housing, and valve cage.

In an exemplary embodiment of the present disclosure, at least one of the circumferential regions is shape-adapted to a fluid passage cross section, which is limited by the at least one fluid inlet or fluid outlet. The first opening cross section can have a diameter, which essentially corresponds to an outer diameter of the outer circumference of the fluid connecting piece.

According to an exemplary further development of the valve cage according to the disclosure, an in particular flat cover is attached to the cage structure. It can be provided, for example, that the cage structure and the cover is made in one piece, in particular by means of a plastic injection molding process. The cover ensures a fluid-tight closing of the valve housing, in particular of the valve chamber limited by the valve housing and of the fluid channel arranged therein.

According to an exemplary further development of the valve cage according to the disclosure, the cage structure is formed essentially hollow-cylindrically and is open towards at least one front side. The other front side can be closed by the cover. For example, the cover is the top side of the cage structure.

In a further exemplary embodiment of the valve cage according to the disclosure, the first opening cross section is formed in a partially circular manner and/or is smaller than the second opening cross section. The partially circular shape can be shape-adapted and/or matched to an in particular cylindrical outer dimension of the fluid connecting piece. The second opening cross section can have an essentially rectangular shape.

In the following description of exemplary embodiments of directional control valves according to the disclosure, which are generally provided with reference numeral 1, for handling fluids, it can be assumed, for example, that they are integrated in coolant circuits of motor vehicles, whereby it is clear that further fields of application are also possible. For example, the directional control valve 1 is produced by means of a plastic injection molding process, so that even complex geometries can be produced, for example in the field of the fluid flow guidance.

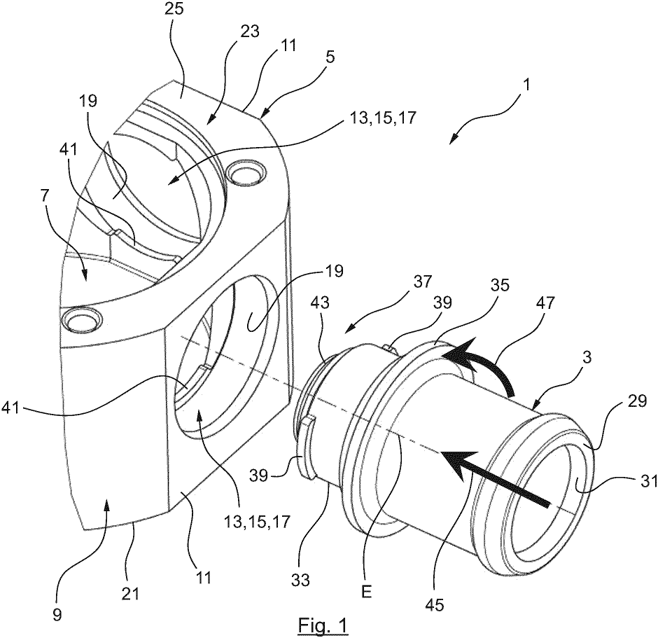

A section of a first exemplary embodiment of a directional control valve 1 according to the disclosure is illustrated in a perspective view, wherein the focus is on the simple attachment of a fluid connecting piece 3 to a valve housing 5 limiting a valve chamber 7. According to FIG. 1, the valve housing 5 is only illustrated partially and is formed essentially as a hollow cylinder comprising an essentially constant wall thickness, wherein an outer circumferential surface 9 of the valve housing 5 differs from a pure cylinder structure, and according to FIG. 1, has four essentially flat circumferential surface sections 11, two of which are illustrated in FIG. 1, and two of which are in each case located opposite one another. The circumferential wall sections 11 each comprise a fluid connection 13, which is formed as round passage opening in the wall of the valve housing. The fluid connections 13 can represent a fluid inlet, a fluid outlet, or, depending on operating or switching position of the directional control valve, respectively, either fluid inlet or fluid outlet. For the following description, a fluid inlet is identified with reference numeral 15, and a fluid outlet with reference numeral 17. The openings of the fluid connections 13, which have a round cross section, are in each case surrounded by an opening wall 19, which limits the opening.

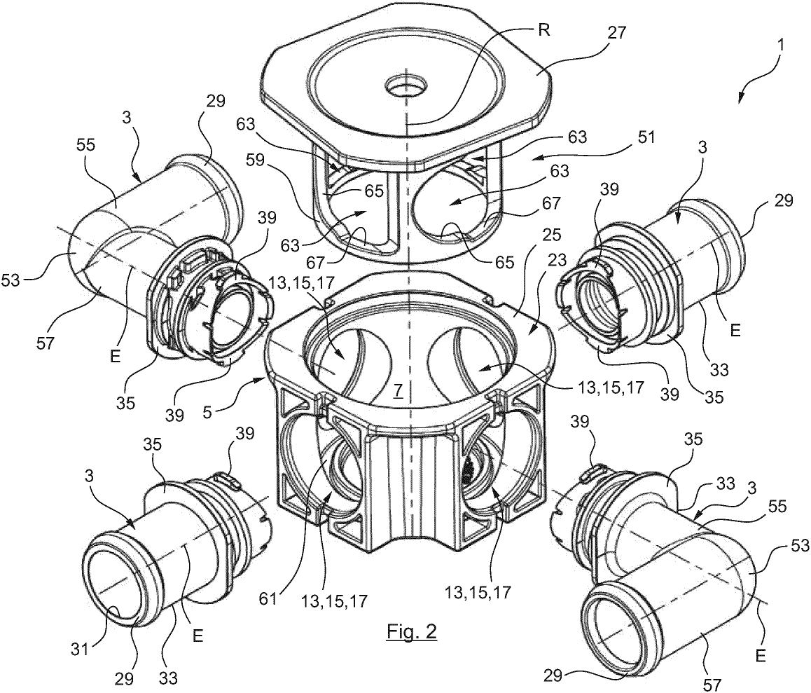

On one side, a bottom side 21 and, located opposite to the latter, a top side 23, is formed on both front sides of the valve housing 5. The top side 23 has an essentially annular, flat bearing or front surface 25, to which a non-illustrated valve cover 27 (FIG. 2) can be attached, in order to close the valve chamber 7 to the top.

The fluid connecting piece 3 essentially has a pipe structure and is formed to be hollow throughout, in order to guide fluid into the valve housing 5 or out of the latter. A rear-side end 29 of the fluid connecting piece 3 is provided so that a fluid line (not illustrated), such as a hose, a pipe, etc., can be connected in order to continue guiding the fluid. On the end 29, the fluid connecting piece 3 has a fluid inlet opening 31. On its outer circumference 33, the fluid connecting piece 3, which has an essentially cylindrical dimension, has a circumferential stop projection 35, wherein the latter does not necessarily have to be circumferential. The stop projection 35 serves the purpose of coming into a stop contact with the valve housing wall, namely the circumferential surface section 11, which limits the fluid connection 13, so that an axial insertion position of the fluid connecting piece 3 into the valve housing 5 is set.

The assembly of the fluid connecting piece 3 and the positive attachment thereof to the valve housing 5 will be discussed below. For the positive attachment, which is in particular releasable or which can be disassembled, respectively, of the fluid connecting piece 3 to the valve housing 5, a bayonet mechanism is provided, which is generally suggested by reference numeral 37. According to FIG. 1, the bayonet mechanism 37 has an engagement element 39, which is formed on the outer circumference 33 of the fluid connecting piece 3 and which has retaining lugs, which, as a pair, in each case revolve around the outer circumference 33 in sections and project from the latter, in particular transversely to the axial direction of the fluid connecting piece 3. The bayonet mechanism 37 further has another engagement element 41, which is formed on the valve housing 5 and which is realized as retaining lug projection from a bottom side of the valve housing in the direction of the top side 23 and which projects into a fluid passage cross section, which is limited by the fluid connection 13 or projects into the latter, respectively. To in particular releasably attach the fluid connecting piece 3 to the valve housing 5, the two engagement elements 39, 41 cooperate with one another. To release or disassemble the fluid connecting piece 3, respectively, from the valve housing 5, the engagement between the engagement elements 39, 41 is reversed again.

To connect the fluid connecting piece 3 and the valve housing 5, the fluid connecting piece 3 is to be axially inserted from the disassembly position illustrated in FIG. 1 into the valve housing 5 via the fluid connection 13, wherein a front-side end 43 located opposite the rear-side end 29, and in the region of which the retaining lugs 39 are also provided, face forwards and thus in the insertion direction E. The axial assembly direction sets an insertion direction E, which is suggested by means of a dashed line in FIG. 1. The fluid connecting piece 3 is inserted so far into the valve housing 5 in the insertion direction E until the fluid connecting piece-side engagement element 39 reaches axially past the at least one further valve housing-side engagement element 41 in the insertion direction E. The insertion movement is suggested by means of the bold arrow with reference numeral 45. In order to fasten the fluid connecting piece 3 to the valve housing 5, in particular releasably, the fluid connecting piece 3, which is inserted into the valve housing 5, in particular all the way to an axial insertion point, at which the stop contact 35 comes into a stop contact with the outer circumferential surface 11, is fastened by means of a rotation to the valve housing 5 by locking the two engagement elements 39, 41 of the fluid connecting piece 3 and of the valve housing 5. The engagement elements 39, 41 can thereby have locking elements for positively/non-positively interlocking. The engagement between the two engagement elements 39, 41 can also take place in that, as a result of the relative rotation of the fluid connecting piece 3 with respect to the valve housing 5, the fluid connecting piece-side engagement element 39 overlaps with the valve housing-side engagement element 41 in the insertion direction E. In FIG. 1, the rotational movement of the fluid connecting piece 3 relative to the valve housing 5 is suggested by means of the curved bold arrow with reference numeral 47. It can be seen in FIG. 1 that the axis of rotation of the fluid connecting piece 3 and the insertion direction E thereof are oriented in parallel, in particular coaxially. Due to the fact that the retaining lugs 39, 41 overlap one another in the insertion direction E, a fastening, which can be realized structurally easily and which can be assembled easily by an installer, of a fluid connecting piece 3 to the valve housing is given.

A further exemplary embodiment of a directional control valve 1 according to the disclosure is shown in FIGS. 2 to 6, wherein FIGS. 2 to 5 illustrate an exemplary assembly sequence of the directional control valve 1. The main components of the directional control valve 1 according to the disclosure can be seen in FIG. 2 in perspective view in an exploded illustration. The directional control valve 1 according to the disclosure of FIGS. 2 to 6 comprises the following main components: the valve housing 5; a non-illustrated valve member 1, which can be moved relative to the valve housing 5, for setting a fluid flow through the directional control valve 1; several, in particular four, fluid connecting pieces 3 for establishing a fluid connection with a respective non-illustrated fluid line to a separate component, for example of a coolant circuit of a motor vehicle; a valve cage 51, which is to be installed in the valve housing 5 and which in particular serves the purpose of storing and/or of guiding the valve member, as well as, according to the second aspect according to the disclosure of the present disclosure, also of the in particular releasable, positive attachment of the fluid connecting piece 3 to the valve housing 5. For the following description of a further exemplary embodiment of the present disclosure, identical or similar components, respectively, are provided with identical or similar reference numerals, respectively.

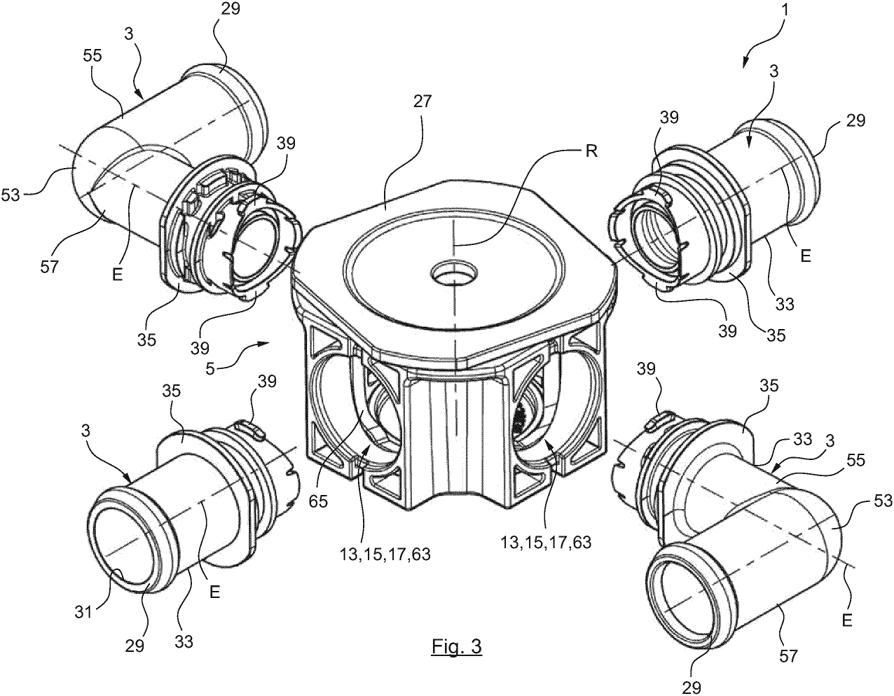

The valve housing 5 is formed essentially similarly to the valve housing from FIG. 1, with the essential difference that the valve housing 5 does not have any engagement elements 41. It can be seen in FIG. 2 that no retaining lugs or the like, which engage with the engagement elements 39, in particular the retaining lugs, which are formed essentially analogously to the fluid connecting pieces according to FIG. 3, are provided for the directional control valve on the valve chamber side in the region of the four fluid connections 13. Two of the fluid connecting pieces 3 are formed in an l-shaped manner, in contrast to the two other fluid connecting pieces 3 according to FIG. 2 and in contrast to the fluid connecting pieces 3 from FIG. 1, which are essentially formed as pipe sections extending completely rectilinearly, and in each case have an angle piece 53, which connects two pipe sections 55, 57 to one another, which are essentially vertical to one another, and which are configured to redirect the fluid flow in the immediate vicinity of the valve housing 5 by means of the non-illustrated fluid line, which is to be connected.

The valve cage 51 can be formed, for example, according to the third aspect according to the disclosure of the present disclosure. The valve cage 51 has a cage structure 59, which is at least partially adapted to an inner contour of the valve housing 5 and which is formed essentially hollow-cylindrically and has a wall with essentially constant wall thickness. Downwards towards one of the front sides, the cage structure 59 is completely open and come into a stop contact or sealing contact, respectively, with a bottom 61 of the valve housing 5, which is illustrated in FIG. 2, in order to close the valve chamber 7 downwards. The valve cage 51 further has a total of four recesses 63, which are essentially formed identically and which are each assigned to a fluid connection 13. The recesses 63 each have a first opening cross section and thus a circumferential region or passage 65, respectively, which defines a fluid passage channel, as well as a second circumferential region 67, which connects directly to the first circumferential region 65 and which differs from the first opening cross section and defines a second opening cross section. The first circumferential region 65 is formed in such a way that it is shape-adapted to a cross section of the fluid connection 13 assigned at the corresponding recess 63, and, in particular, it has, in sections, an essentially identical cross section. It can be seen in FIG. 2 that the first opening cross section is partially circular, wherein a radius is adapted with respect to the fluid connections 13. The larger, second opening cross section 67 forms an essentially rectangular window. The valve cage 51 further comprises a cover 27, which is connected to the cage structure 59, in particular made in one piece therewith, in particular by means of a plastic injection molding process, and which closes and/or seals the valve chamber 7 to the top.

The directions, in which the individual components are to be installed in the valve housing 5, are illustrated by means of dashed lines: insertion direction E and installation direction R. It can be seen thereby that the insertion directions E of the fluid connecting pieces 3 are oriented vertically to the installation direction R of the valve cage 51. All insertion directions E of all fluid connecting pieces 3 further lie in a plane, on which the installation direction R is vertically based. The advantage of the embodiment according to FIGS. 2 to 6 is that a positive engagement between valve cage 51, valve housing 5, and all fluid connecting pieces 3 can be established by means of the valve cage 51 and the bayonet mechanism 37, in order to fasten all components to one another, in particular releasably. For this purpose, the fluid connecting piece-side engagement elements 39 in each case come into a positive engagement with the valve cage 51. A further advantage of the embodiment according to FIGS. 2 to 6 is that the valve housing-side engagement elements 41 can be forgone, whereby the manufacture of the directional control valve 1 is further simplified.

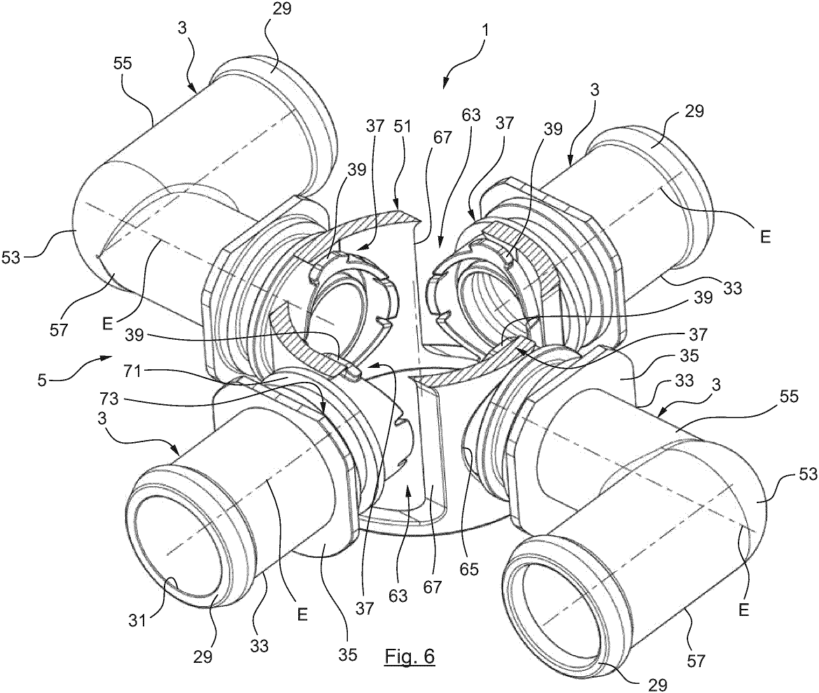

The assembly, in particular the disassembly, will be discussed in more detail with reference to FIGS. 3, 4, and 5. The bayonet mechanism 37 is shown on the basis of FIGS. 6 to 8. FIG. 3 represents a pre-assembly state, in which the valve cage 51 is axially installed in the valve housing, in particular in the valve chamber 7, in a translatory manner along the installation direction R thereof. With regard to the installation direction R, which also represents an axis of rotation of the valve cage 51 relative to the valve housing 5, the valve cage 51 is arranged with respect to the valve housing so that the second circumferential region 67 is assigned to the respective fluid connections 13, in particular is arranged so as to be aligned therewith. In the region of the cover 27, it can be seen that the latter is not yet oriented completely with respect to the front side 25 of the valve housing 5, but is still rotated by a few degrees.

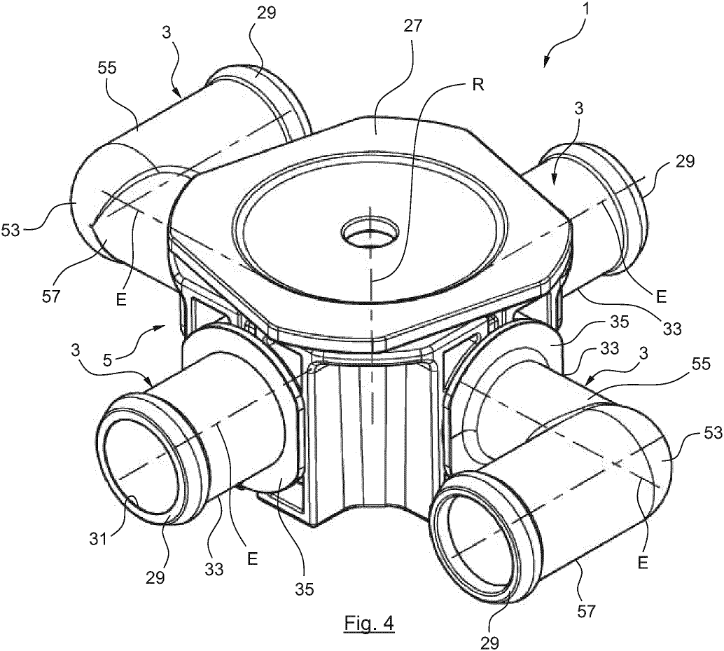

FIG. 4 shows an intermediate assembly state of the directional control valve 1, in the case of which the fluid connecting pieces 3 are inserted into the valve housing 5 along the insertion direction E via the respective fluid connections 13. The fluid connecting pieces 3 are inserted into the valve housing 5 so far that the respective stop projections 35 come into a stop contact with the valve housing outer side 9. With respect to the direction of rotation R, the valve cage 51 is furthermore still in the position according to FIG. 3, i.e. not completely oriented yet.

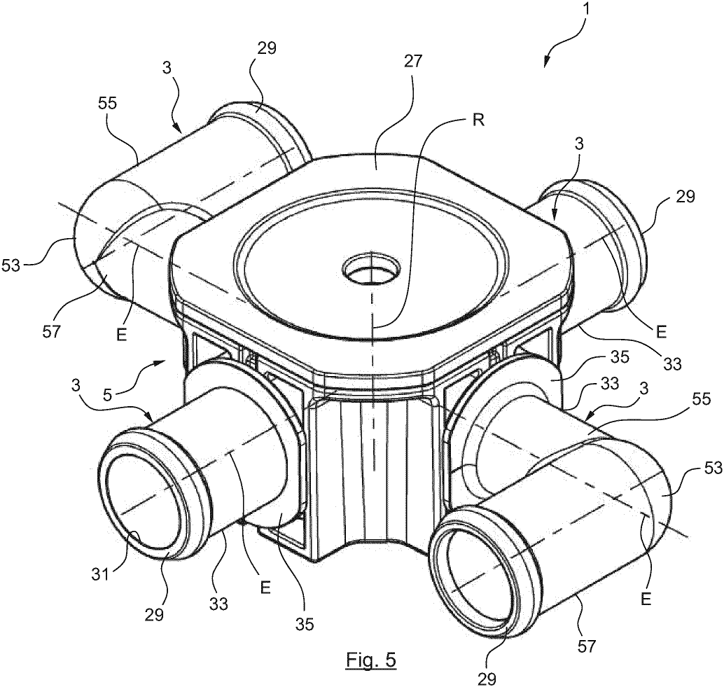

Lastly, the final assembly state of the directional control valve 1 is illustrated in FIG. 5. In a combined view of FIGS. 4 and 5, it can be seen that the valve cage 51 is rotated slightly about the axis of rotation, which forms the installation direction axis R, in order to activate the bayonet mechanism 37. The rotation of the valve cage relative to the valve housing and relative to the fluid connecting pieces 3 is accompanied by a positive engagement between the fluid connecting pieces 3, namely the fluid connecting piece-side engagement elements 39, and the valve cage 51. The cover 27 is now oriented essentially completely flush with the front side 25 of the valve housing 5. The valve cage 51 is now furthermore oriented in such a way with respect to the valve housing 5 that the first circumferential region 65 are in each case oriented essentially aligned with the fluid connections 13.

FIG. 6 shows a sectional view of the directional control valve 1 in the final assembly state according to FIG. 5, wherein the valve housing 5 is omitted for a better visualization of the bayonet mechanism 37 and of the associated positive engagement between the fluid connecting pieces 3 and the valve cage 51. It can be seen in FIG. 6 that the fluid connecting pieces 3 are inserted so far into the valve housing 5 in the insertion direction E that the engagement elements 39 reach/es axially past the cage structure, in particular the cage structure wall, in the insertion direction E, so that the engagement elements 39 engage behind the valve cage wall or overlap it in the insertion direction E, respectively, after the rotation of the valve cage 51 relative to the valve housing 5 and the fluid connecting pieces 3.

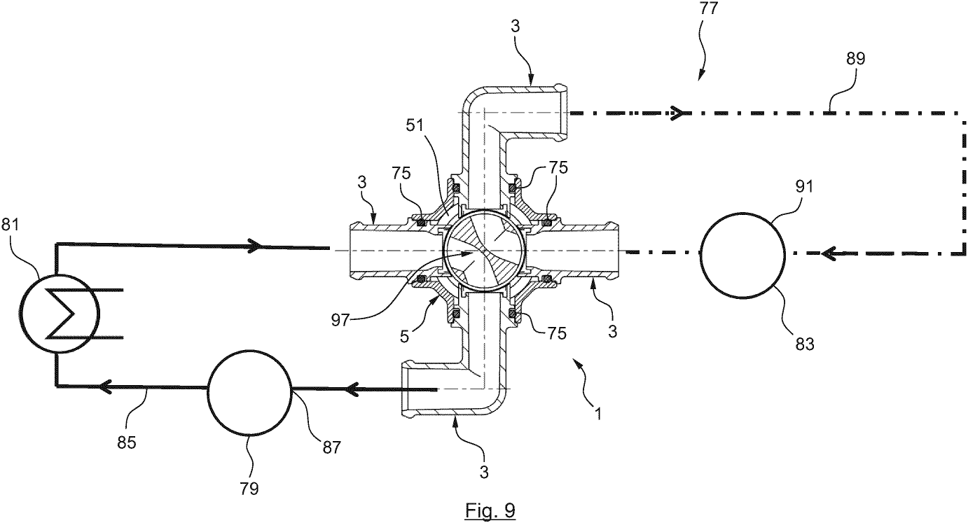

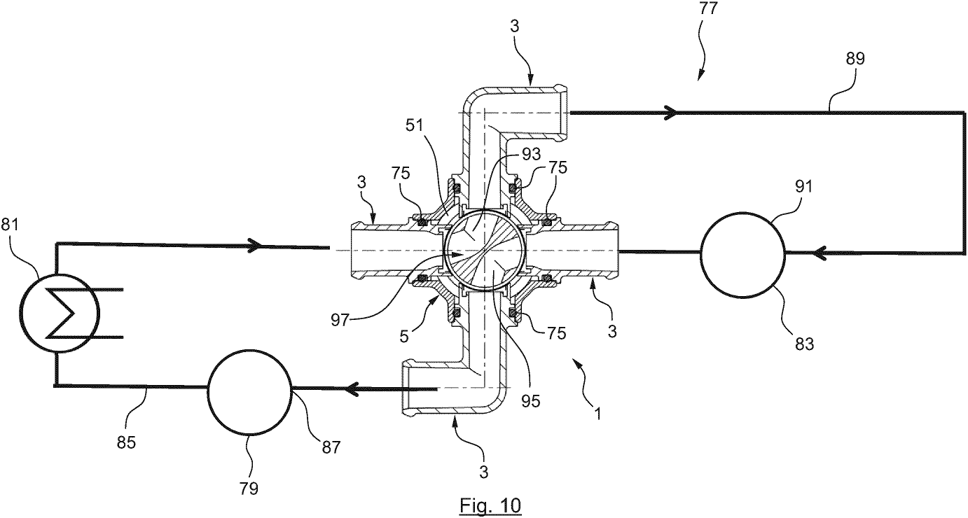

Furthermore, the double effect of the fastening of the bayonet mechanism 37 according to the disclosure further becomes clear from FIG. 6: on the one hand, the positive engagement between the fluid connection-side engagement element 39 and the cage wall has the effect that the fluid connecting piece 3 is fixed in the valve housing 5 in the insertion direction E because the engagement element 39 abuts against the cage wall and is retained by the latter with respect to the insertion direction E. As can be seen in particular in FIG. 6, the fluid connecting pieces have a sealing projection 71, which revolves essentially annularly, between the stop projection 35 and the engagement element 39, viewed in the insertion direction E. As is shown, for example, in FIG. 6, a distance between sealing projection 71 and engagement element 39 is adapted to a wall thickness dimensioning of the cage structure 59. It is thus ensured that the fluid connecting piece 3 and the valve cage 51 are fastened firmly, in particular without play, so that this is associated with a compact, firm coupling, without, for example, the fluid connecting piece 3 rocking or wobbling, respectively, with respect to the remaining components. Viewed in the insertion direction E between the stop projection 35 and the sealing projection 71, a sealing groove 73 is formed, in which a non-illustrated sealing element, for example an O-ring, can be installed for sealing the valve chamber 7. The sealing element 75 can be seen, for example, in FIGS. 9 and 10. Furthermore, the bayonet mechanism 37 also ensures a fastening of the valve cage 51 to the valve housing 5. Owing to the fluid connecting pieces 3, which project through the recesses 63 of the valve cage 51, the valve cage 51 is fixed within the valve housing 5 with respect to its installation direction R. A disassembly of the valve cage 51 can thus only be made possible in the case of the disassembled fluid connecting piece 3.

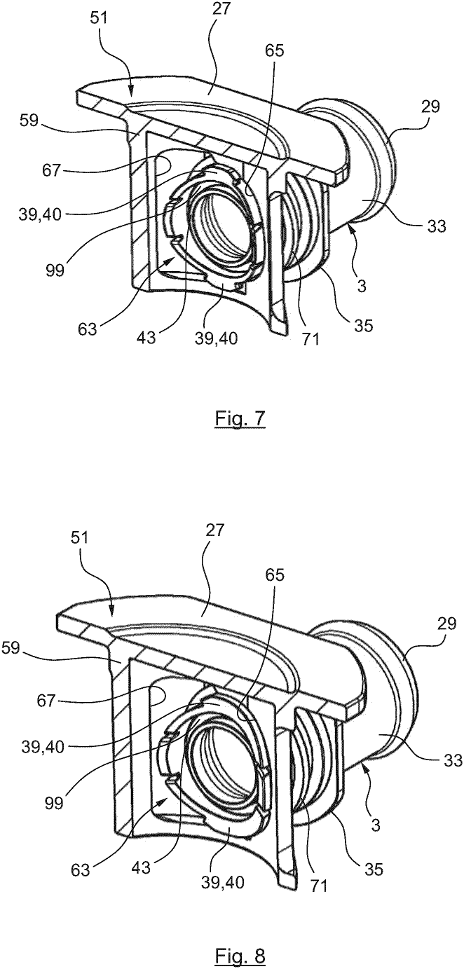

Partial sectional views of the multi-way valve 1 according to FIGS. 2 to 6 are shown in FIGS. 7 and 8, wherein alternative embodiments of the fluid connecting piece-side engagement elements 39 can be seen. The engagement element 39 according to FIG. 7 comprises two retaining lugs 40, which are located diametrically opposite one another and which project radially on the outside of the outer circumference 33 of the fluid connecting piece. The retaining lugs 40 extend in the circumferential direction by approximately 5 degrees to approximately 15 degrees. It can be seen in FIG. 8 that instead of the separate retaining lugs 40, which are located diametrically opposite one another, an essentially cohesive retaining collar 75 is provided on the fluid connecting piece 3, which extends in the circumferential direction by approximately 180 degrees. When providing a circumferential retaining collar 75 of this type, the retaining force against a disassembled fluid connecting piece 3 from the valve housing and the valve cage 51 is significantly larger compared to the narrow retaining lugs 40 with the embodiment from FIG. 7.

The front-side end 43 and engagement element 39 are arranged at a distance from one another in the radial direction, thus transversely to the insertion direction E, so that a circumferential gap 99 results, which forms a sealing groove for receiving a seal (not illustrated).

With reference to FIG. 9, a coolant circuit 77, for example of a motor vehicle, in particular of an electrically operated motor vehicle, is illustrated schematically. A multi-way valve 1 according to the disclosure is integrated in the coolant circuit 77. For example, the coolant circuit 77 can serve the purpose, of realizing a thermal management for an engine 79 of the motor vehicle. A radiator 81 as well as a heating device 83 is further integrated in the coolant circuit 77. As follows from the combined view of FIGS. 9 and 10, a different fluid circuit can be established via an operating state of the multi-way valve 1. For this purpose, an actuator 83, which is illustrated schematically as rotary valve member, is rotated relative to the valve housing 5, in order to form different switching positions and to thus provide for different fluid flows.

An operating state is illustrated in FIG. 9, which involves, for example, feeding cooled fluid to the engine, in order to avoid an overheating of the engine 79. As shown by means of the bold arrows, suggested by reference numeral 85, engine fluid leaves the engine 79 in the direction of the radiator 81, where the temperature of the engine fluid, which is heated by the engine 79, is tempered, in particular cooled down. The cooled engine fluid subsequently reaches into the multi-way valve 1 via one of the fluid connecting pieces 3. There, the fluid flow is redirected by means of the valve member 83 so that it can be guided back directly to the engine 79. This means that the actuator 83 feeds the fluid flow to that fluid connecting piece 3, which is in fluid connection with an engine fluid inlet 87 of the engine 79. The valve member 83 is further dimensioned and/or formed in such a way that it forms a flow loss-free, in particular laminar, flow through the multi-way valve 1. This is not associated with flow losses, there is no dynamic pressurization, and a particularly efficient operation of the multi-way valve 1 is thus possible. It can further be seen in FIG. 9 that a partial fluid flow section 89, which is illustrated by means of the dashed arrow, is capped. This means that no fluid flow flows over the partial fluid flow section to heat the fluid flow by means of the heating device 83.

In contrast, FIG. 10 shows a multi-way valve position, in which the fluid flow flows along the complete coolant circuit 77. This means that the actuator 83 is positioned in such a way that the fluid flow arriving from the radiator 81 is redirected in the direction of that fluid connecting piece 3, which fluidically communicates with a radiator fluid inlet 91 of the heating device 83. There can be operating states, for example, in which the cooled cooling fluid is to not be fed directly to the engine 79, but a heated fluid, in order to avoid an undercooling of the engine 79. This can be necessary, for example, in a cold-start phase at particularly cold ambient temperatures. The valve member 83 is dimensioned so that it sets two fluid channels through the valve housing 5, namely a first fluid channel, which connects the radiator 81 to the heating device 91, and a second fluid channel 85, which connects the heating device 91 to the engine 79.

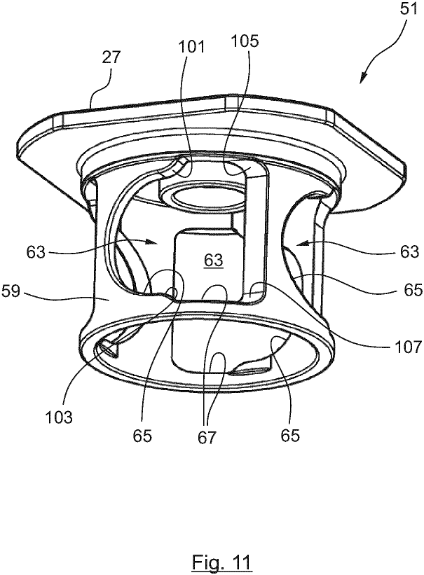

An exemplary embodiment of a valve cage 51 according to the disclosure, which can be used, for example, in a multi-way valve 1 according to the disclosure, is illustrated in FIG. 11 in perspective view and in an isolated manner. The valve cage 51 is formed essentially analogously to the embodiment in the preceding figures. Reference can thus generally be made to the preceding description. The four essentially identically formed recesses 63, which are to each be assigned to a fluid connection 13, can be seen in FIG. 11. It can further be seen in particular that the second circumferential region 67 of the recesses 63 extends almost over the entire vertical height of the cage structure 59 and has an essentially rectangular basic cross section. The second circumferential region 67 transitions directly into the first circumferential region 65 for forming one of the recesses 63, wherein the first circumferential region 65 essentially has a semicircular contour. The transitions 101, 103 between first circumferential region 65 and second circumferential region 67 are curved convexly and thus provide for a simple relative rotation between valve cage 51 and valve housing 3. the convexly curved transitions 101, 103 have a centering and/or guiding property compared to the respective fluid connecting piece. The second circumferential region 67 further has corners 105, 107, which are rounded, in particular formed concavely, and which are located opposite the transitions 101, 103.

The features disclosed in the above description, the figures, and the claims, can be important for the realization of the disclosure in the various designs, both individually and in any combination.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Reference List

| | |
|---|---|
| 1 | directional control valve |
| 3 | fluid connecting piece |
| 5 | valve housing |
| 7 | valve chamber |
| 9 | valve housing wall |
| 11 | wall section |
| 13 | fluid connection |
| 15 | fluid inlet |
| 17 | fluid outlet |
| 19 | opening wall |
| 21 | bottom side |
| 23 | top side |
| 25 | front surface |
| 27 | cover |
| 29 | end |
| 31 | opening |
| 33 | outer circumference |
| 35 | stop projection |
| 37 | bayonet mechanism |
| 39 | engagement element |
| 40 | retaining lug |
| 41 | engagement element |
| 43 | end |
| 45 | insertion element |
| 47 | rotational movement |
| 51 | valve cage |
| 53 | angle piece |
| 55, 57 | pipe section |
| 59 | cage structure |
| 61 | bottom |
| 63 | recess |
| 65 | first circumferential region |
| 67 | second circumferential region |
| 71 | sealing projection |
| 73 | sealing groove |
| 75 | retaining collar |
| 77 | coolant circuit |
| 79 | engine |
| 81 | cooling device |
| 83 | heating device |
| 85 | cooling fluid circuit |
| 87 | engine fluid inlet |
| 89 | heat fluid circuit |
| 91 | radiator fluid inlet |
| 93 | first fluid channel |
| 95 | second fluid channel |
| 97 | valve member |
| 99 | sealing groove |
| 101, 103 | transition |
| 105, 107 | corner |
| E | insertion direction |
| R | installation direction |

1. A directional control valve for handling fluids in a motor vehicle, the directional control valve comprising:
a valve housing defining at least one fluid channel comprising at least one fluid inlet and at least one fluid outlet; and
at least one fluid connector adapted to the at least one fluid inlet or fluid outlet and including a bayonet mechanism configured to positively connect to the valve housing.

2. The directional control valve according to claim 1, wherein the at least one fluid connector includes a at least partially circumferential stop projection on its outer circumference, the stop projection being configured to come into stop contact with a valve housing wall limiting the at least one fluid inlet or fluid outlet to establish an axial insertion position of the fluid connector.

3. The directional control valve according to claim 1, wherein the bayonet mechanism comprises at a first engagement element formed on the outer circumference of the fluid connector and the valve housing comprises a second engagement element formed on the valve housing and that projects into a fluid passage cross section limited by the at least one fluid inlet or fluid outlet.

4. The directional control valve according to claim 3, wherein the first engagement element is configured to reach past the second engagement element in response to the fluid connecting piece being inserted into the at least one fluid inlet or fluid outlet in an insertion direction.

5. The directional control valve according to claim 3, wherein the bayonet mechanism is configured such that, in response to the fluid connector being inserted into the at least one fluid inlet or fluid outlet in an insertion direction and rotated, the first engagement element is configured to engage the second engagement element, a final assembly position of the fluid connector corresponding to an aligned orientation of the first engagement element with the second engagement element.

6. The directional control valve according to claim 5, wherein an axis of rotation of the fluid connector and the insertion direction of the fluid connector are oriented parallel to one each other in the at least one fluid inlet or fluid outlet.

7. The directional control valve according to claim 3, wherein the first engagement element is arranged on the fluid connector and/or second engagement element is arranged on the valve housing such that the engagement elements are free from a flow-around of the fluid flow.

8. The directional control valve according to claim 1, further comprising a valve cage configured to be installed in the valve housing.

9. The directional control valve according to claim 8, wherein the bayonet mechanism is configured to establish a positive fastening between valve cage, the valve housing, and the at least one fluid connector.

10. The directional control valve according to claim 8, wherein the first engagement element is configured to come into a positive engagement with the valve cage.

11. The directional control valve according to claim 10, wherein the bayonet mechanism is configured such that the first engagement element is configured to positively engage the valve cage in response to the fluid connector being inserted into the at least one fluid inlet or fluid outlet and the valve cage being rotated.

12. The directional control valve according to claim 10, wherein the valve cage comprises at least two recesses assigned to the at least one fluid inlet and to the at least one fluid outlet, the at least two recesses including a first circumferential region, which defines a first opening cross section, and a second circumferential region, which differs from the first opening cross section and defines a second opening cross section.

13. The directional control valve according to claim 12, wherein the positive engagement between fluid first engagement element and valve cage comprises the first circumferential region overlapping the second engagement element and/or the first engagement element reaching past the first circumferential region in the insertion direction.

14. The directional control valve according to claim 12, wherein the first opening cross section is shape-adapted to an outer circumference of the fluid connector.

15. The directional control valve according to claim 14, wherein the direction control valve 1s configured such that:
in a pre-assembly state, the valve cage is installable in the valve housing such that the at least one fluid inlet or the at least one fluid outlet is oriented with the second opening cross section of the recess,
in an intermediate assembly state, the fluid connecting piece is insertable through the fluid inlet or fluid outlet and the valve cage-side recess, and
in a final assembly state, the first opening cross section is configured to be oriented with the fluid inlet or fluid outlet, and the fluid connecting piece is arrangeable in the first opening cross section.

16. A valve cage for a directional control valve having a valve housing defining at least one fluid channel including at least one fluid inlet and at least one fluid outlet and at least one fluid connecting piece adapted to the at least one fluid inlet or fluid outlet, the valve cage comprising;
a cage structure at least partially adapted to an inner contour of the valve housing,
wherein the cage structure includes two recesses assigned to the at least one fluid inlet and the at least one fluid outlet, each of the two recesses including a first circumferential region defining a first opening cross section, and a second circumferential region, which differs from the first opening cross section, and which defines a second opening cross section.

17. The valve cage according to claim 16, wherein at least one of the first and second circumferential regions is shape-adapted to a fluid passage cross section limited by the at least one fluid inlet or fluid outlet.

18. The valve cage according to claim 16, further comprising a cover configured to attach to the cage structure.

19. The valve cage according to claim 18, wherein the cage structure is hollow-cylindrically shaped and is open towards first side of the cage structure, wherein a second side opposite the first side is closed by the cover.

20. The valve cage according to claim 16. wherein the first opening cross section is partially circular and/or is smaller than the second opening cross section.
